(19) United States
(12) Patent Application Publication
(10) Pub. No.: US 2014/0157018 A1
(43) Pub. Date: Jun. 5, 2014

(54) POWER MODULE AND ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/023,473

(22) Filed: Sep. 11, 2013

(30) Foreign Application Priority Data
Dec. 4, 2012 (CN) 2012105115229

(51) Int. Cl. G06F 1/32

(52) U.S. Cl. CPC G06F 1/3234
USPC 713/320

(57) ABSTRACT

A power module to power a function module of an electronic device is provided. The power module includes a power unit, a switch unit, a timing unit, and a control unit. The switch unit is connected between the power unit and the function module, and establishes or cuts off a connection between the power unit and the function module. The timing measures a time has elapsed according to a timing length. The control unit is connected to the timing unit and the switch unit, and is used to start the timing unit to measure time after the electronic device has been turned on. The timing unit produces a trigger signal when the measured time reaches the timing length, the control unit turns off the switch unit when receiving the trigger signal, thus cutting off connection between the power unit and the function module.

### BACKGROUND

1. Technical Field

The present disclosure relates to power modules.

2. Description of Related Art

Electronic devices, such as tablet computers, portable computers, usually can be shut down by timing control. For example, some downloaded software installed in the electronic device can control the electronic device to be soft shut down when a download task has been finished. However, when the electronic device is turned on again, if a user needs the electronic device to be turned off at a certain time, the user needs to open the software and set the time that the electronic device is to be turned off again. It is inconvenient for the user.

A power module and an electronic device to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device with a power module.

FIG. 2 is a schematic diagram of an embodiment of an electronic device with a power module.

### DETAILED DESCRIPTION

Embodiments of the present disclosure will be described with reference to the accompanying drawings.

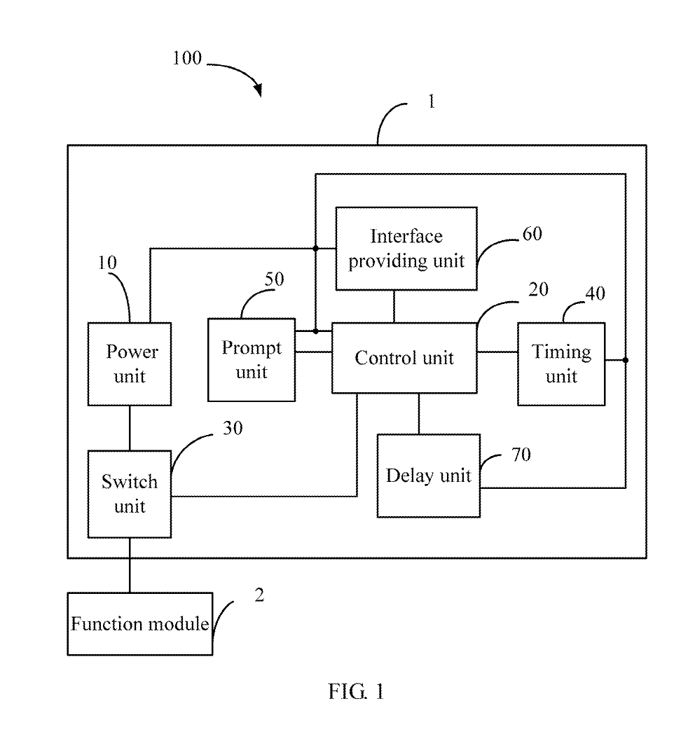

FIG. 1 illustrates a block diagram of an embodiment of an electronic device 100. The electronic device 100 includes a power module 1 and a function module 2. The power module 1 provides power to the function module 2 and manages the power to the function module 2 according to a shutdown time set by a user. The function module 2 includes a processing unit, a storage unit, a codec chip, and any other function units applied by the electronic device 100.

The power module 1 includes a power unit 10, a control unit 20, a switch unit 30, and a timing unit 40. The power unit 10 is used to output power voltage. The power unit 10 can be a battery, a power adapter, and the like. The power unit 10 is connected to the control unit 20 and the timing unit 40, and provides power to the control unit 20 and the timing unit 40.

The switch unit 30 is connected between the power unit 10 and the function module 2, and is used to establish a connection between the power unit 10 and the function module 2 or cut off the connection between the power unit 10 and the function module 2. When the connection between the power unit 10 and the function module is established, the power unit 10 powers the function module 2. When the connection between the power unit 10 and the function module is cut off, the power unit stops powering the function module 2 accordingly. The switch unit 30 can be a metal-oxide -semiconductor field effect transistor (MOSFET) or the similar structure.

The timing unit 40 has set a time length, the timing unit 40 is used to measure the time elapsed according to the time length. The control unit 20 is connected to the timing unit 40 and the switch unit 30, and is used to start the timing unit 40 to measure time after the electronic device 100 is turned on. The timing unit 40 produces a trigger signal when the time reaches the timing length.

The control unit 20 turns off the switch unit 30 when receiving the trigger signal, thus the connection between the power unit 10 and the function module 2 is cut off, and the power unit 10 stops powering the function module 2. The control unit 20 can be a single chip, a microcontroller, or the like. The control unit 20 outputs a high voltage signal or a low voltage signal to the switch unit 30 to turn off the switch unit 30. In detail, if the switch unit 30 is a P-channel MOSFET (PMOSFET), the control unit 20 output the high voltage signal to the switch unit 30 to turn off the switch unit 30, if the switch unit 30 is a N-channel MOSFET (NMOSFET), the control unit 20 output the low voltage signal to the switch unit 30 to turn off the switch unit 30.

In the embodiment, the switch unit 30 can be a metal-oxide-semiconductor field effect transistor or a bipolar junction transistor, the control unit 20 outputs a high voltage signal or a low voltage signal to the switch unit 30 to turn off the switch unit 30 when receiving the trigger signal. In another embodiment, the switch unit 30 can be a computer controlled switch.

In the embodiment, the timing unit 40 is a timer.

In the embodiment, the power module 1 also includes an interface providing unit 50, the interface providing unit 50 is used to provide a user interface for the user to input data or for outputting prompt information to the user. In the embodiment, the interface providing unit 50 is used to receive a password and a shutdown time information input by the user. The password is used to verify an authority of the user. For example, when one user sets the shutdown time information, the user must input a correct password first. In the embodiment, the interface providing unit 50 can be a touch screen. In another embodiment, the interface providing unit 50 includes a keyboard (not shown) and a display unit (not shown), the keyboard is provided for the user to input data, the display unit displays corresponding information to the user in response to the data input by the user via the keyboard.

The control unit 20 is also used to verify the password input by the user via the interface providing unit 50, and control the interface providing unit 50 to produce prompt information to prompt the user to input the shutdown time information after verifying the password is correct. In the embodiment, the shutdown time information input by the user can be a particular time, such as, 22:00, or can be a time length, such as, 2 hours.

The control unit 20 sets the timing length of the timing unit 40 according to the shutdown time information input by the user. For example, if the shutdown time information is the particular time, the control unit 20 calculates an interval between current time and the particular time, and then sets the interval as the timing length of the timing unit 40. If the shutdown time information is the time length, the control unit 20 sets the time length as the timing length of the timing unit 40 directly. For example, if the user sets to shutdown the electronic device 100 after 2 hours, namely the time length is 2 hours, then the control unit 20 sets the timing length of the timing unit 40 as 2 hours. In the embodiment, the control unit 20 also can change the password in responses to user operation after the control unit 20 verifies the previous password input by the user is correct.

In the embodiment, the power module 10 also includes a prompt unit 60 connected to the control unit 20, the prompt unit 60 is used to produce a prompt signal. The control unit 20 also controls the prompt unit 60 to produce the prompt signal when determining a time measured by the timing unit 40 reaches a predetermined time length less than the timing length of the timing unit 40, thus prompting the user that the electronic device 100 will to be shutdown. In the embodiment, the control unit 20 controls the prompt unit 60 to produce an audio signal or a visible signal. The prompt unit 60 can be an audio output unit or a light-emitted diode.

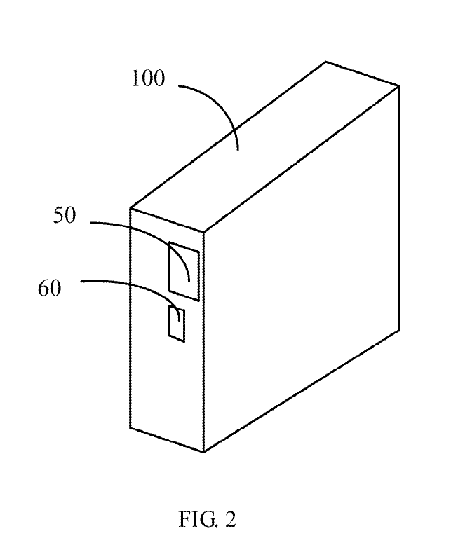

FIG. 2 shows that the interface providing unit 50 and the prompt unit 60 are both located outside of the electronic device 100, which facilitates the user to operate the electronic device 100 and obtain the prompt signal.

Referring to FIG. 1 again, in the embodiment, the power module 1 also includes a delay unit 70 connected to the control unit 20. The control unit 20 also starts the delay unit 70 when turning off the switch unit 30, and turns on the switch unit 30 again after a predetermined delay time length of the delay unit 70 has elapsed. In the embodiment, the control unit 20 maintains the switch unit 30 to turn off before the delay time length has elapsed.

In the embodiment, the delay unit 70 also can be a timer, the control unit 20 controls the delay unit 70 to measure time when controlling the switch unit 30 to turn off, the delay unit 70 produces an on signal after the predetermined delay time length has elapsed. The control unit 20 controls the switch unit 30 to turn on when receiving the on signal from the delay unit 70. In another embodiment, the delay unit 70 can be a delayer.

In the embodiment, when the control unit 20 verifies a password input by the user is correct. Then a duration is determined from the time the electronic device is turned off to the time that the user inputs the password, making sure the duration is less than the predetermined delay time length. The control unit 20 turns on the switch unit 30 to enable the power unit 10 to provide power to the function module 2. Thus, the user who has the authority can turn on the electronic device 100 any time.

The electronic device 100 can be a table computer, a desktop computer, a portable computer, a server, a mobile phone, a digital photo frame, and an electronic reader, for example.

In the embodiment, the power unit 10 is connected to the control unit 20, the timing unit 40, the interface providing unit 50, the prompt unit 60, and the delay unit 70, and provides power to them, thus, the control unit 20, the timing unit 40, the interface providing unit 50, the prompt unit 60, and the delay unit 70 remain working when the electronic device 100 is turned off.

In the present disclosure, the user only needs to set the shutdown time information one time via the interface providing unit 50, then the electronic device 100 can be turned on and off according to the shutdown time information and the predetermined delay time length periodically.

It is understood that the present embodiments and their advantages will be understood from the foregoing description, and various changes may be made thereto without departing from the spirit and scope of the disclosure or sacrificing all of its material advantages, the examples hereinbefore described merely being embodiments of the present disclosure.

What is claimed is:

1. A power module comprising:
a power unit configured to provide power to a function module of an electronic device;
a switch unit connected between the power unit and the function module, and configured to establish a connection between the power unit and the function module or cut off the connection between the power unit and the function module;
a timing unit being set a timing length, and configured to measure a time elapsed according to the timing length; and
a control unit connected to the timing unit and the switch unit, and configured to start the timing unit to measure time after the electronic device has been turned on;
wherein, the timing unit produces a trigger signal when the measured time reaches the timing length, the control unit turns off the switch unit when receiving the trigger signal, thereby cutting off connection between the power unit and the function module.

2. The power module according to claim 1, further comprising an interface providing unit configured to provide a user interface and receive a password and a shutdown time information input by the user; wherein the control unit is further configured to verify the password input by the user via the interface providing unit, and control the interface providing unit to produce a prompt information to prompt the user to input the shutdown time information after verifying the password is correct, and set the timing length of the timing unit according to the shutdown time information input by the user.

3. The power module according to claim 2, wherein the shutdown time information is a particular time or a time length.

4. The power module according to claim 2, further comprising a delay unit connected to the control unit, wherein the control unit is further configured to start the delay unit when turning off the switch unit, and turn on the switch unit again after a predetermined delay time length of the delay unit has elapsed.

5. The power module according to claim 4, wherein the control unit controls the delay unit to measure time when controlling the switch unit to turn off; the delay unit produces an on signal after measuring the predetermined delay time length has elapsed, the control unit controls the switch unit to turn on when receiving the on signal from the delay unit.

6. The power module according to claim 4, wherein the control unit verifies the password input by the user is correct and a duration from a time the electronic device is turned off to a time that the user inputs the password is less than the predetermined delay time length, the control unit turns on the switch unit to provide power to the function module.

7. The power module according to claim 1, further comprising a prompt unit connected to the control unit, wherein the control unit is further configured to produce a prompt signal when determining a time measured by the timing unit reaches a predetermined time length less than the timing length of the timing unit.

8. An electronic device comprising:
a function module; and
a power module comprising:
a power unit configured to provide power to a function module of an electronic device;
a switch unit connected between the power unit and the function module, and configured to establish a connection between the power unit and the function module or cut off the connection between the power unit and the function module;
a timing unit being set a timing length, and configured to measure a time elapsed according to the timing length; and
a control unit connected to the timing unit and the switch unit, and configured to start the timing unit to measure time after the electronic device has been turned on;
wherein, the timing unit produces a trigger signal when the measured time reaches the timing length, the control unit turns off the switch unit when receiving the trigger signal, thereby cutting off connection between the power unit and the function module.

9. The electronic device according to claim 8, wherein the power module further comprises an interface providing unit configured to provide a user interface and receive a password and a shutdown time information input by the user; the control unit is further configured to verify the password input by the user via the interface providing unit, and control the interface providing unit to produce a prompt information to prompt the user to input the shutdown time information after verifying the password is correct, and set the timing length of the timing unit according to the shutdown time information input by the user.

10. The electronic device according to claim 9, wherein the shutdown time information is a particular time or a time length.

11. The electronic device according to claim 9, wherein the power module further comprises a delay unit connected to the control unit, the control unit is further configured to start the delay unit when turning off the switch unit, and turn on the switch unit again after a predetermined delay time length of the delay unit has elapsed.

12. The electronic device according to claim 11, wherein the control unit controls the delay unit to measure time when controlling the switch unit to turn off; the delay unit produces an on signal after measuring the predetermined delay time length has elapsed, the control unit controls the switch unit to turn on when receiving the on signal from the delay unit.

13. The electronic device according to claim 11, wherein the control unit verifies the password input by the user is correct and a duration from the electronic device is turned off to the time that the user inputs the password is less than the predetermined delay time length, the control unit turns on the switch unit to provide power to the function module.

14. The electronic device according to claim 8, wherein the power module further comprises a prompt unit connected to the control unit, the control unit is further configured to produce a prompt signal when determining a time measured by the timing unit reaches a predetermined time length less than the timing length of the timing unit.

15. The electronic device according to claim 8, wherein the electronic device is one selected from a group consisting of a table computer, a desktop computer, a portable computer, a server, a mobile phone, a digital photo frame and an electronic reader.
